(19) United States
(12) Patent Application Publication
(10) Pub. No.: US 2001/0000859 A1
(43) Pub. Date: May 10, 2001

(54) Web rotary hot stamping soft-die plate system

(76) Inventors: Raymond T. Lomax, Boca Raton, FL (US); Thomas C. Gray, Coral Springs, FL (US)

Correspondence Address: BARLOW, JOSEPHS & HOLMES, LTD., 101 DYER STREET, 5TH FLOOR, PROVIDENCE, RI, 02903, US

(21) Appl. No.: 09/755,237

(22) Filed: Jan. 5, 2001

Related U.S. Application Data
(63) Continuation of application No. 09/395,820, filed on Sep. 14, 1999.

(51) Int. Cl. B31F 1/07; B44B 5/00; B41F 19/02

(52) U.S. Cl. 101/25

(57) ABSTRACT

A hot stamping cylinder for webs includes a mounting cylinder, a longitudinal channel extending running along the substantial entirety of the length thereof. A flexible substrate plate includes a leading edge flange substantially parallel to the flexible substrate plate and offset a distance substantially equal to the depth of the channel. A trailing edge flange is also provided which is substantially parallel to the flexible substrate plate and offset a distance substantially equal to the depth of the channel. A layer of silicone material is positioned on the flexible substrate plate where the layer of silicone material has a relief pattern thereon which corresponds to a desired stamping pattern. A longitudinal clamp resides in the channel and retains the leading edge flange and the trailing edge flange within the channel thereby securing the substrate plate, with silicone relief pattern thereon, to the mounting cylinder in preparation for use in a web hot stamp operation.

### BACKGROUND OF THE INVENTION

1. This application is a continuation of U.S. Ser. No. 09/395,820, filed Sep. 14, 1999.

2. The present invention relates to printing and hot stamping machines and more particularly to a web rotary hot stamp soft-die plate system that replaces existing solid metal rotary hot stamp die cylinders.

3. The printing and hot foil stamping onto webs has been known in the prior art for many years. For example, web printing is common in the newspaper and commercial printing industry where a large number of web presses have been employed. In addition, machines have been developed for printing on non-web materials, such as plastic items and bottles. Additionally, flexographic web presses have been developed for printing on a variety of rolled substrate materials, such as paper, board, film or laminated and non-laminated film stock. In addition to the printing of ink onto web and non-web materials, hot stamping operations have also been utilized to provide a way to highlight the indicia on an article or web to make it more attractive.

4. In the prior art, hot stamping has become a popular technique to make a web or article more attractive. Such techniques are so well known in the art that only an overview of these methods is required. For example, cold foil transfer employs a print station that includes a special water-based adhesive while another print station is configured to provide the pressure needed to transfer the foil. Hot stamping commonly employs a flat-bed of heated metal or silicone die to accommodate flat articles while round articles may be accommodated by silicone dies or silicone marking rollers. In the web printing, packaging and converting industry, solid rotary dies of brass or other metallic materials are employed.

5. However, the printing systems of the prior art for hot stamping suffer from many disadvantages. One of the primary problems with prior art hot stamping systems, particularly for the web printing industry, is trauma to the web. As stated above, prior art systems employ a solid metallic die cylinder made of brass or other metal. During normal operation, the solid metallic die cylinder relentlessly strikes the web thus causing undue trauma to the web. Such severe trauma, commonplace in web hot stamping operations, causes frequent breaks to the web material and breakdown in the accuracy in the registration of the foil transfer. Moreover, when using label material, the web trauma crushes the adhesive resulting in poor release and performance of the completed label upon application.

6. In addition to the foregoing, prior art web hot stamping systems suffer from the problems of additional cost of consumable soft base rolls, waste generated on existing systems, extensive downtime caused by the web trauma, excessive downtime due to registration and die changeover. Further, due to the existence of web trauma, press speeds may be reduced significantly to ensure accurate registration. As can be understood, slower press speeds delays the completion of jobs and/or can dramatically increase the cost of a job as a result.

7. Still further, fixed equipment costs of existing web hot stamping systems is a major problem for web printers, particularly a printer of smaller size. The high costs of web hot stamping, due to the equipment and dies, has made it cost prohibitive for smaller, less capitalized, companies from entering the hot stamping business. More specifically, the cost of the rotary hot stamping dies alone is very significant and can range from $1000 to $10,000 per die cylinder, per job. Also, the aforementioned metal cylinders of brass or the like, are time consuming to manufacture. Also, the metal cylinders are delicate and require special handling to avoid damage.

8. In view of the foregoing, there is a demand for an improved web rotary hot stamping system that is less expensive than the metal cylinders of the prior art and avoids trauma to the web. There is also a demand for a web rotary hot stamp die that is less fragile than prior art rotary hot stamp dies. There is a further demand for a web rotary hot stamp die that is easy and fast to manufacture. There is a particular demand for a web rotary hot stamp system that is easy to install and that is retrofittable to existing die or print stations. There is also a demand for a web rotary hot stamp die that is less susceptible to damage than prior art dies.

### SUMMARY OF THE INVENTION

9. The present invention preserves the advantages of prior art printing and hot stamping machines. In addition, the improved web rotary hot stamp system of the present invention provides new advantages not found in currently known systems and overcomes many disadvantages of such currently available systems. The invention is generally directed to the novel and unique soft-die plate for web printing. The soft-die plate system for web rotary hot stamping includes a mounting cylinder, a longitudinal channel extending and running along the substantial entirety of the length thereof. A flexible substrate plate includes a leading edge flange substantially parallel to the flexible substrate plate and offset a distance substantially equal to the depth of the channel. A trailing edge flange is also provided which is substantially parallel to the flexible substrate plate and offset a distance substantially equal to the depth of the channel. A layer of silicone material is positioned on the flexible substrate plate where the layer of silicone material has a relief pattern thereon which corresponds to a desired stamping pattern. A longitudinal clamp resides in the channel and retains the leading edge flange and the trailing edge flange within the channel thereby securing the substrate plate, with a silicone relief pattern thereon, to the mounting cylinder in preparation for use in a web rotary hot stamp operation.

10. For use and operation of the web rotary hot stamp soft-die plate of the present invention, the mounting cylinder is mounted into a cylinder support frame and is provided with meshing gear teeth for engagement with the base roll. The substrate plate is wrapped around the mounting cylinder with the silicone relief pattern facing in an outward direction. The flanges on the leading and trailing edges of the substrate plate are placed into the longitudinal channel and the longitudinal clamp is secured into place, thus securing the substrate plate, and silicone thereon, on the mounting cylinder in preparation for use in a rotary hot stamp web printing operation.

11. Accordingly, it is a primary object of the instant invention to provide an improved web rotary hot stamp soft-die plate system.

12. Another object of the instant invention is to provide a soft-die plate that includes a relief pattern and is easily mountable and removable from the mounting cylinder.

13. Still further, an object of the instant invention is to provide a soft-die plate that is less expensive and easier to manufacturer than prior art rotary hot stamping metal dies.

14. It is yet another object of the present invention to provide a soft-die plate system that does not impart trauma to the web during operation.

15. A further object of the present invention is to provide a soft-die plate system that reduces the overall cost of operating and maintaining web press speed.

16. Another object of the present invention is to provide a soft-die plate system that reduces the time to change soft-die plates for repair or between jobs, while using the same mounting cylinder.

17. Yet a further object of the present invention is to provide a soft-die plate system that utilizes a reusable mounting cylinder that is retrofittable to an existing die or print station.

18. Another object of the present invention is to provide a soft-die plate system that dramatically increases equipment up-time, thereby increasing cost effectiveness and cost efficiency.

### BRIEF DESCRIPTION OF THE DRAWINGS

19. The novel features which are characteristic of the present invention are set forth in the appended claims. However, the invention's preferred embodiments, together with further objects and attendant advantages, will be best understood by reference to the following detailed description taken in connection with the accompanying drawings in which:

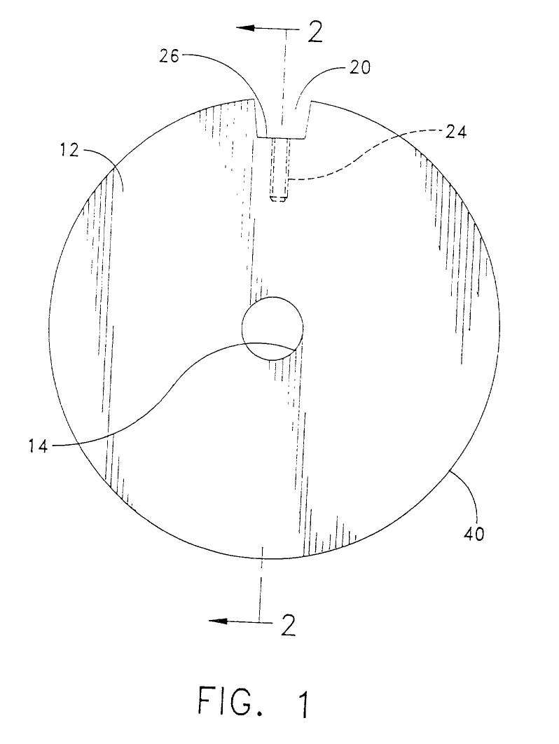

20. FIG. 1 is an end elevational view of the mounting cylinder in accordance with the present invention;

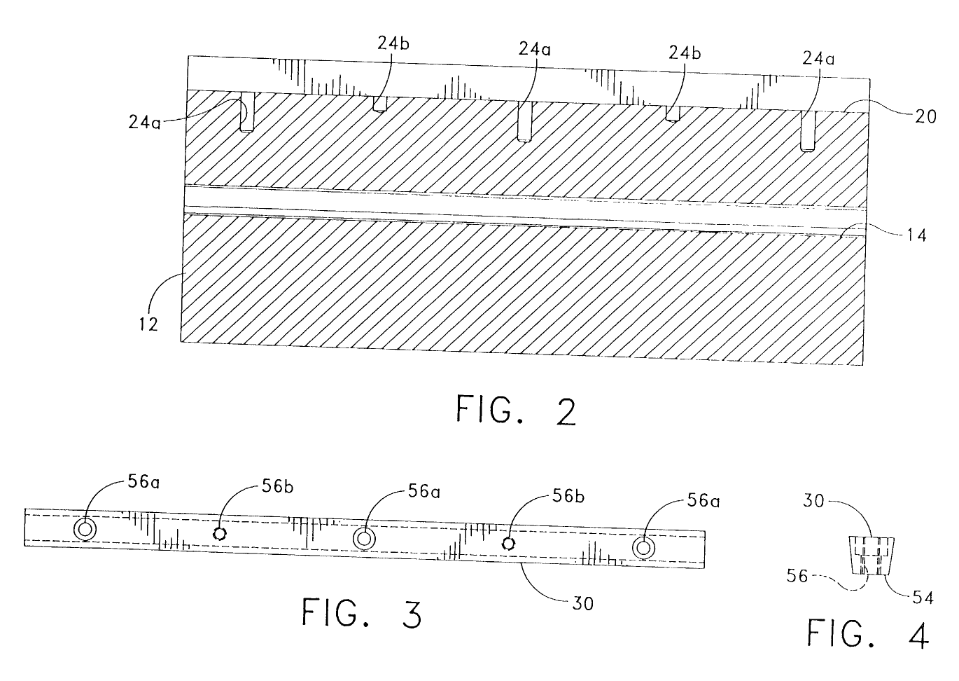

21. FIG. 2 is a cross-sectional view through the line 2—2 of FIG. 1;

22. FIG. 3 is a top view of the longitudinal clamp of the soft-plate die web hot stamp system of the present invention;

23. FIG. 4 is an end view of the longitudinal clamp shown in FIG. 3;

24. FIG. 5 is an end elevational view of the soft-die plate web cylinder in accordance with the present invention;

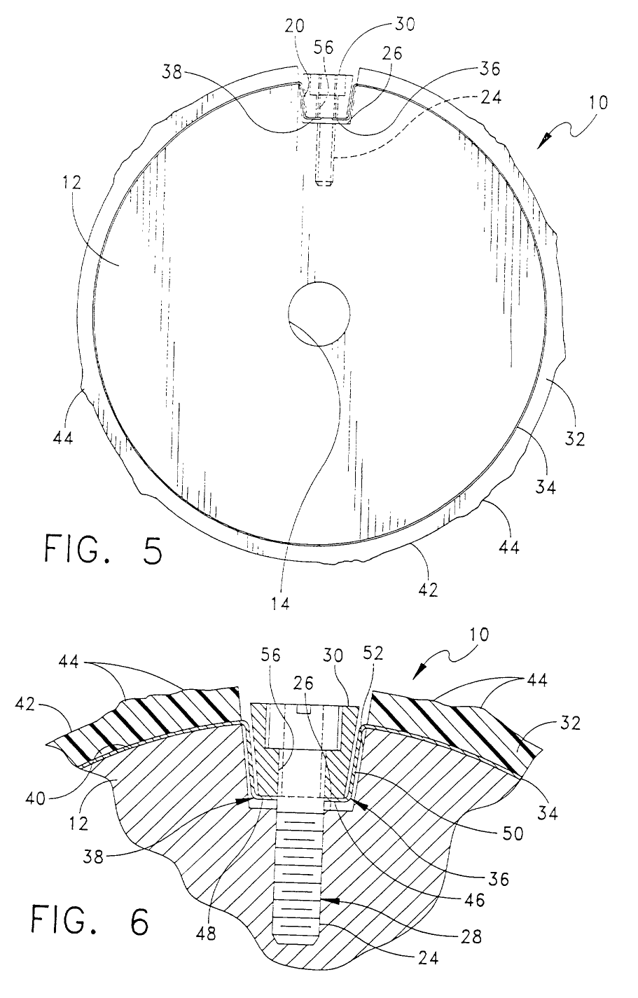

25. FIG. 6 is a close-up cross-sectional view of the soft-die plate web hot stamp cylinder illustrating the fastening of the substrate plate to the mounting plate;

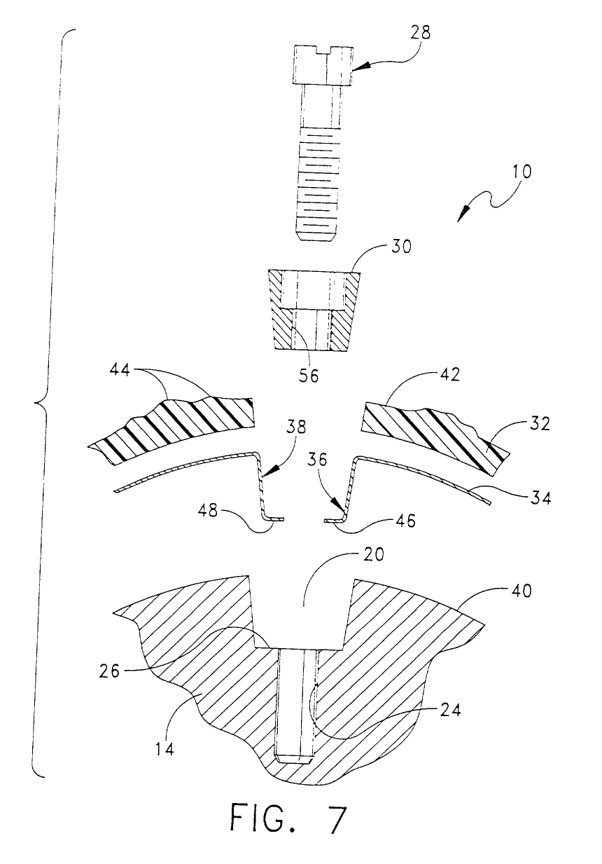

26. FIG. 7 is an exploded view of the assembly in FIG. 6;

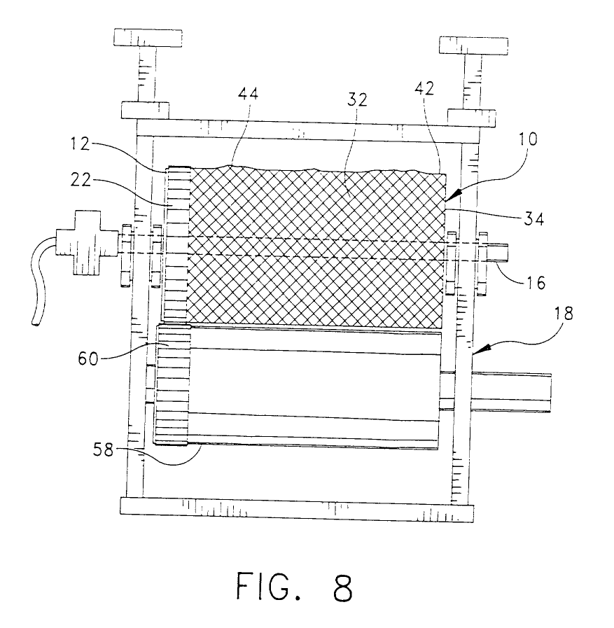

27. FIG. 8 is a front elevational view of the soft-die plate web hot stamp cylinder mounted with a base roll in a cylinder support frame in accordance with the present invention; and

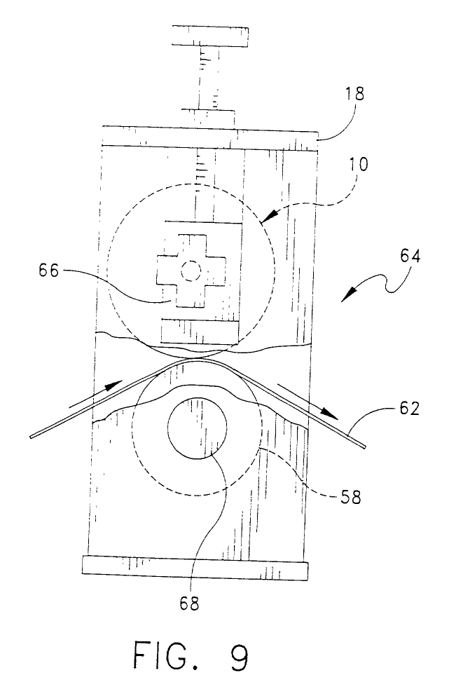

28. FIG. 9 is an end view of the assembly shown in FIG. 8.

### DETAILED DESCRIPTION OF THE PREFERRED EMBODIMENT

29. FIGS. 1-7, the web hot stamp soft-die plate 10 of the present invention is shown. Referring to FIGS. 1 and 2, a mounting cylinder 12 is employed as the base of the web hot stamp soft-die plate 10 (shown fully assembled in FIG. 5) of the present invention. The mounting cylinder 12 includes a circular cross-section with a longitudinal bore 14 running along the central longitudinal axis of the cylinder. As will be discussed in detail below, longitudinal bore 14 receives a heat probe axle 16, as shown below in FIG. 8, which enables the die plate 10 to be easily mounted on a cylinder support frame 18 for use in a hot stamping job. A longitudinal channel 20 of a predetermined depth is provided in the mounting cylinder 12 and, preferably, extends along the entire length of the mounting cylinder 12. On one end of the mounting cylinder 12, as will be described below, gear teeth 22 are provided for precise image repeat. A series of female threaded bores, generally referenced as 24, are provided in the floor 26 of the channel 20 to receive fasteners 28 to secure a clamp 30 which is discussed below in connection with FIG. 3 and 4. More specifically, jack screws (not shown) are engagable with threaded apertures 24b. It is preferred that the mounting cylinder 12 has a length of approximately 10 inches, a diameter of approximately 9 inches with a channel depth of approximately ½inch. The mounting cylinder 12 is preferably made of aluminum. While these dimensions and materials are preferred, the size, configuration and materials of the mounting cylinder 12 and the soft-die plate 10 may be modified to suit the size of the press and application or job at hand.

30. In FIGS. 3 and 4 a longitudinal clamp 30 is provided which resides within the channel 20 in the mounting cylinder 12. FIG. 3 shows a top view of the clamp 30, where the clamp 30 is configured to be of a length substantially equal to the length of the mounting cylinder 12 with a portion at one end reserved for gear teeth 22 (in FIG. 8) for gear driving the mounting cylinder 12. FIG. 4 shows an end view of the clamp 30 with a cross-sectional configuration that is substantially similar to the cross-sectional configuration of the channel 20. Such a complementary fit ensures a strong attachment of the clamp 30 into the channel 20.

31. Turning now to FIGS. 5-7, the attachment of the clamp 30 and, most importantly, the connection of the silicone layer 32 and substrate plate 34. FIG. 5 shows an end view of the assembled web hot stamp soft-die plate 10 in accordance with the present invention. FIG. 6 illustrates a close-up view of the construction employed for retaining the substrate plate 34 and silicone layer 32 in place during operation. FIG. 7 shows an exploded view of the construction of FIG. 6 to illustrate the details of the interconnection of the clamp 30 and how the substrate plate 34 is secured to the mounting cylinder 12.

32. In FIG. 5, the mounting cylinder 12 is provided to carry a substrate plate 34 that has a layer of silicone rubber 32 affixed thereon. The substrate plate 34 is removably affixed to the mounting cylinder 12 by the unique construction using the longitudinal clamp 30. The substrate plate 34 has a leading edge 36 and a trailing edge 38, which terminate in the channel 20. The body of the substrate plate 34 is dimension to cover substantially the entire outer surface 40 of the mounting cylinder 12 and is, preferably, made of aluminum but can be made of other suitable materials, such as flexible shim stock backing. A layer of silicone rubber 32 is affixed or deposited on the side of the substrate plate 34 that does not communicate with the mounting cylinder 12. The layer of silicone 32 travels with the substrate plate 34 and is, as a result, easily removable from the mounting cylinder 12. The layer of silicone 32 is preferably adhered to the substrate plate 34 by a special bonding agent and then vulcanized. The top exposed surface 42 of the silicone rubber 32 is formed with the desired relief pattern that corresponds with the die operation of the job at hand. As a result, the soft-die plate 10 of the present invention can be easily customized to suit the application. The relief pattern is formed in the silicone 32 by utilizing a photo-engraved magnesium plate which forms a sunken mold. As seen in FIG. 5, in accordance with the present invention, a unique silicone relief pattern 44 is removably provided about the outer surface of the mounting cylinder thus simulating the cylindrical relief pattern of prior art web hot stamp dies without the cost associated with such solid dies or the hard metal relief pattern that causes trauma to the web. Further the removable substrate plate/silicone rubber construction 32 and 34 enables the easy replacement of the die pattern for maintenance, repair or for a new die plate with a new relief pattern for the next job.

33. FIGS. 6-7 show details of the configuration of clamp 30 and how the substrate plate 34 is secured to the mounting cylinder 12. The leading edge 36 and trailing edge 38 of the substrate plate 34 are both bent downwardly a distance approximately equal to the depth of the channel 20 and then bent inwardly a distance less than half of the width of the floor of the channel 20 to form a leading edge flange 46 and a trailing edge flange. The leading edge flange 46 and the trailing edge flange 48, as can be understood, preferably run the entire length of the substrate plate 34 and can be formed using a crimping die (not shown), or the like.

34. To install the substrate plate 34, carrying the silicone 32 with relief pattern 44, the leading edge flange 46 is first placed into the channel 20 with the downwardly depending wall 50 of the flange 46 seating substantially parallel to side wall 52 of the channel 20 with the inwardly bend portion of the leading edge flange 46 resting proximal to the channel floor 26 to the right of the female threaded bores 24. The substrate plate 34 is wrapped around the mounting cylinder 12 and the trailing edge flange 48 is similarly installed into the channel 20 on the opposite side of the row of female threaded bores 24 in the floor 26 of the channel 20. The clamp 30 is then inserted into the channel 20 thus securing the inwardly positioned flanges 46 and 48 between the lower surface 54 of the clamp 30 and the floor 26 of the channel 20. Flanges 46 and 48 need not touch the floor 26 of the channel 20. Fasteners 28, are routed through bores, generally referenced as 56, in the clamp 30 into threaded communication with corresponding female threaded bores 24 in the floor 26 of the channel 20. Jack screws (not shown) are preferably received through bores 56b, and fasteners 28 received in bores 56a. While male threaded fasteners 28 and jack screws and female threaded bores 24a and 24b are preferred to secure the clamp 30 in place, other methods for fastening the clamp in place may be employed.

35. Referring now to FIGS. 8 and 9, the installation of the web hot stamp soft-die plate into equipment is shown. FIGS. 8 and 9 illustrate such an installation by way of example to illustrate the flexibility of use of the soft-die plate 10 of the present invention. The present invention may be used in any press or station that requires a die for hot stamping. The soft-die plate 10, including the substrate plate 34 and silicone 32 secured to the mounting plate 12, is installed in a cylinder support frame 18 which includes a center heat probe axle 16and teeth 22 mounted about the diameter of the mounting cylinder 12 to enable precise gear driving of the soft-die plate 10 and precise mass control. In this application, the substrate plate 34 and silicone 32 covers entire length of the mounting cylinder 12 with the exception of the area covered by the teeth 22. A base roll 58 with gear teeth 60, is also mounted in the cylinder support frame 18 below and the soft-die plate 10 of the present invention. The base roll 58, as best seen in FIG. 9, provides the primary support for a web 62 through the die station, generally referenced as 64. The base roll 58 and cylinder support frame 18 need not be discussed in detail as such cylinder and frames are well known in the prior art. In addition, the details of hot foil stamping need not be discussed in detail but it should be understood that the soft-die plate 10 of the present invention can be easily incorporated into such stations and effectively replace existing solid metal dies of the prior art.

36. Further, the present invention includes the novel positioning of the soft-die plate 10 relative to the base roll 58. In accordance with the present invention, as best seen in FIG. 9, the soft-die plate 10 and base roll 58 are positioned eccentrically relative to one another by offsetting of the respective impression support blocks 66 and 68. The eccentricity of the soft-die plate 10 allows more cylinder dwell time on the web surface and therefore produces a more effective transfer of the foil.

37. The present invention is particularly useful when being installed in a cylinder support frame 18 as shown in FIGS. 8 and 9. With the soft-die plate 10 of the present invention, the mounting cylinder 12 need not be removed from the cylinder support frame 18, which saves time and money and avoids unnecessary down time. Further, the mounting cylinder 12 can remain on the cylinder support frame 18 and the substrate plate 34 and silicone 32 thereon can be easily and quickly removed for replacement with a different plate for a new job, variable repeat or for repair and maintenance. The soft-die plate 10 of the present invention enables the cost of the hot stamping to be kept low while providing high definition silicone carrying plates. The mounting cylinder 12 is maintained in every job while the inexpensive substrate plate 34 and silicone 32 thereon is changed to suit the job. Since the silicone carrying plates 34 are removable, off line proofing, registration and quick turn around is possible unlike prior art solid metal dies. The soft-die plate10 can be easily modified to fit into idle roll or in-feed/nip roll assemblies unlike the prior art which requires placement in an existing die station or custom designed unit. Further, the flexible soft-die plate 10 of the present invention can be operated at lower temperatures than prior art brass cylinders which enables the soft-die plate 10 to accommodate a wide range of foils and web materials.

38. It would be appreciated by those skilled in the art that various changes and modifications can be made to the illustrated embodiments without departing from the spirit of the present invention. All such modifications and changes are intended to be covered by the appended claims.

What is claimed is:

1. A method for foil hot stamping, comprising the steps of:
providing a die station support frame;
providing a mounting cylinder having a longitudinal axis, an outer surface, a circumference, and a core;
providing a flexible substrate plate;
positioning a layer of silicone rubber on said flexible substrate plate forming a silicone rubber relief pattern;
removably securing said flexible substrate plate and said silicone rubber relief pattern thereon about said mounting cylinder;
mounting said mounting cylinder in said die print station support frame; said mounting cylinder being rotatable about said longitudinal axis of said mounting cylinder;
providing a base roll having a longitudinal axis and a circumference;
eccentrically mounting said base roll in said die print station support frame relative to said mounting cylinder; said base roll being rotatable about said longitudinal axis of said base roll;
heating said mounting cylinder, said flexible substrate plate and said silicone rubber relief pattern thereon;
providing a foil hot stamping web;
routing said foil hot stamping web between said mounting cylinder and said base roll;
rotating said mounting cylinder about its longitudinal axis in a first direction while simultaneously rotating said base roll about its longitudinal axis in a second direction opposite to said first direction; and
imparting said relief pattern, that has been heated, to said foil hot stamping web thereby transferring a foil pattern to a substrate.

2. The method of claim 1, further comprising the steps of:
providing a first tooth pattern about the circumference of said mounting cylinder;
providing a second tooth pattern about the circumference of said base roll;
meshing said first tooth pattern with said second tooth pattern; and
rotating said mounting cylinder in synchronization with said base roll.

3. The method of claim 1, further comprising the step of:
inserting a heat probe into said core of said mounting cylinder.

4. The method of claim 1, further comprising the step of:
positioning said mounting cylinder offset relative to said base roll to increase dwell time of said silicone relief pattern on said foil hot stamping web.

5. The method of claim 1, wherein said step of providing a flexible substrate plate comprises providing a flexible aluminum substrate plate.

6. The method of claim 1, wherein said step of removably securing said flexible substrate plate and said silicone rubber relief pattern thereon about said mounting cylinder comprises removably securing said flexible substrate plate and said silicone rubber relief pattern thereon about said mounting cylinder with fasteners.

7. The method of claim 1, wherein said step of mounting said mounting cylinder in said die print station support frame comprises mounting said mounting cylinder via support blocks in said die print station support frame.

8. The method of claim 1, wherein said step of eccentrically mounting said base roll in said die print station support frame comprises eccentrically mounting said base roll via support blocks in said die print station support frame.
